(19) United States
(12) Patent Application Publication
(10) Pub. No.: US 2022/0332038 A1
(43) Pub. Date: Oct. 20, 2022

(54) ADDITIVE MANUFACTURING OF COMPOSITES WITH SHORT-FIBER REINFORCEMENT

(71) Applicant: UNIVERSITY OF MIAMI, MIami, FL (US)

(72) Inventor: Emrah CELIK, Miami, FL (US)

(21) Appl. No.: 17/761,824

(22) PCT Filed: Sep. 17, 2020
(86) PCT No.: PCT/US2020/051176

§ 371 Date: Mar. 18, 2022

Related U.S. Application Data
(60) Provisional application No. 62/903,529, filed on Sep. 20, 2019.

(51) Int. Cl. B29C 64/106; B33Y 10/00; B33Y 30/00; B29C 64/209

(52) U.S. Cl. CPC B29C 64/106; B33Y 10/00; B33Y 30/00; B29C 64/209; B29K 2507/04

(57) ABSTRACT

Additive manufacturing of composites with short-fiber reinforcement. In an embodiment, an extrusion channel is supplied with a composite ink comprising short fibers, and the composite ink is extruded out of a material outlet of the extrusion channel, while vibrating the extrusion channel and the material outlet by one or more vibration motors along one or more vibration axes, to fabricate a three-dimensional composite structure. The short fibers may comprise milled carbon fibers having an average length of 50 μm or less and an average aspect ratio of 4.5 or less, and the composite ink may comprise a high fiber volume ratio (e.g., 27+%). Despite analytical models that predict otherwise, the composite structures, resulting from disclosed embodiments, have enhanced strength.

### CROSS-REFERENCE TO RELATED APPLICATIONS

This application claims priority to U.S. Provisional Patent App. No. 62/903,529, filed on Sep. 20, 2019, which is hereby incorporated herein by reference as if set forth in full.

### BACKGROUND

### Field of the Invention

The embodiments described herein are generally directed to additive manufacturing, and, more particularly, to enhancing the strength in additively manufactured fiber-reinforced composites.

### Description of the Related Art

The design and manufacture of lightweight composite materials have attracted growing interest due to their potential to replace metals, which are the dominant materials for structural applications. Recent progress in additive manufacturing has accelerated this interest, since weight reduction can be enhanced with topology optimization without sacrificing structural performance. Additive manufacturing is based upon building three-dimensional (3D) objects by adding successive layers of material. This enables the fabrication of materials in complex geometries. In addition, with this freedom of manufacturability, the weights of components can be reduced without sacrificing the component's function.

The reduction in weights of components can be accelerated if lightweight materials are used in the additive manufacturing. In this regard, continuous fiber reinforced polymer composites have great potential, since the mechanical performance of these material systems match those of their metallic counterparts, but with significantly lower density. However, additive manufacturing that uses continuous fibers to reinforce polymer composites has a number of geometric and processing constraints, including a minimal deposition length and minimal corner radius. Additive manufacturing that, instead, uses short fibers to reinforce polymer composites allows considerably more freedom in the fiber placement and material deposition, which results in easier processing of the material. Material cost and void content (i.e., porosity) are also relatively lower in short-fiber composites than in continuous-fiber composites, which make short fibers an attractive option for many additive-manufacturing applications.

In studies, chopped polymer, glass, and carbon fibers were mixed with thermoplastic resins, such as polylactic acid (PLA) and acrylonitrile butadiene styrene (ABS), and short-fiber-reinforced composites were fabricated by melting and extruding thermoplastic polymer matrix using a fused filament fabrication (FFF) additive-manufacturing method. In these studies, a significant increase in tensile strength and elastic modulus were observed, as compared to a neat, unreinforced thermoplastic matrix with the addition of short fibers. Enhanced stiffness in these composites significantly reduced the distortion and warping of the material during processing and enabled 3D printing of larger scale components, such as the chassis of a car and the hull of a submarine. Although, thermoplastic composites could be fabricated and 3D-printed successfully with high volume ratios of short fibers (e.g., approximately 40%), the maximum tensile strength of these composites was below 100 megapascals (MPa). This was due to the porosity between the print lines, which is unavoidable in the FFF process, and poor interfacial adhesion between the fibers and the thermoplastic matrix. These processing issues limited the strength—and therefore, the applications—of additively-manufactured thermoplastic composites.

FIG. 1 illustrates the relationship between fiber volume ratio (also referred to as “fiber volume fraction” or “fiber load”) and strength of the short-fiber-reinforced thermoset and thermoplastic composites produced in these studies. As illustrated, there were printability and strength limitations that prevented the production of high-strength composites in these studies. Adhesion between fibers and the polymer matrix is much stronger in thermoset composites in which the fibers are coated with a thin layer of surfactant, which chemically couples the thermoset matrix and the fiber, thereby creating a strong adhesion. In thermoset composites, liquid resin can be used to wet the fiber surface to facilitate the chemical adhesion process.

As an alternative to the FFF process, which is based on polymer melting and solidification, a direct-write process can be used for additive manufacturing of liquid thermoset materials. In the direct-write process, a viscous composite paste or “ink,” with sufficient strength to hold shape, is prepared by mixing liquid polymer resins with fiber reinforcements and rheology-modifying nanoparticles. The composite ink is then extruded into the intended three-dimensional geometry. Finally, the extruded composite material is cured via heat or light into a solid three-dimensional structure.

Direct-write additive manufacturing was introduced by Compton and Lewis to fabricate carbon-fiber-reinforced epoxy composites in 2014. See “3D-Printing of Lightweight Cellular Composites,” by Compton et al., Adv. Mater. 26, 5930−+, doi:10.1002/adma.201401804 (2014), which is hereby incorporated herein by reference as if set forth in full. This process has been adopted to fabricate different thermoset matrices (e.g., epoxy, cyanate ester, and bismaleimide) reinforced with short (discontinuous) carbon or Kevlar fibers.

As demonstrated by FIG. 1, additively manufactured thermoset composites are stronger than thermoplastic composites with the same amount of fiber loading. However, maximum short-fiber loading in these studies was limited to less than 5% by volume. It was reported that chopped fibers in excess of 5% by volume resulted in discontinuous flow, nozzle clogging, and the prevention of fabrication. See “Mechanical Properties of Printed Epoxy-Carbon Fiber Composites,” by Pierson et al., Experimental Mechanics 59, 843-57, doi:10.1007/s11340-019-00498-z (2019), which is hereby incorporated herein by reference as if set forth in full.

Thus, as summarized in FIG. 1, short-fiber-reinforced thermoplastic composites are strength-limited, due to the high level of porosity and insufficient adhesion between the thermoplastic polymer and the fibers in these materials. Thermoset composites provide much higher strength due to the excellent chemical coupling between the fibers and the thermoset matrix. However, additive manufacturing of these systems is extremely difficult over 5% fiber loading. In sum, additively manufactured, short-fiber-reinforced polymer composites have advantages over traditional continuous fiber composites, including lower cost and higher design flexibility in fabrication. However, these composites have low strength and stiffness compared to their continuous-fiber counterparts, due to the requirement of low fiber loads in these material systems.

### SUMMARY

Accordingly, embodiments of systems and methods are disclosed for enhancing the strength of additively manufactured short-fiber-reinforced composites. These embodiments may take advantage of a fictitious fiber-length transformation.

In an embodiment, a method of manufacturing a fiber-reinforced composite is disclosed. The method may comprise: supplying an extrusion channel with a composite ink comprising short fibers having an average length of 50 μm or less and an average aspect ratio of 4.5 or less; and extruding the composite ink out of a material outlet of the extrusion channel, while vibrating the extrusion channel and the material outlet by one or more vibration motors along one or more vibration axes, to fabricate a three-dimensional composite structure. The short fibers may comprise milled carbon fibers. The one or more vibration motors may comprise a plurality of vibration motors. The one or more vibration axes may comprise at least six vibration axes.

Supplying the extrusion channel with the composite ink may comprise, by at least one processor, controlling an actuator to feed the composite ink into the extrusion channel. The actuator may comprise a motor that drives a piston, and wherein feeding the composite ink into the extrusion channel comprises controlling the motor to drive the piston to push the composite ink from a supply chamber into the extrusion channel. Extruding the composite ink out of the material outlet of the extrusion channel may comprise, by at least one processor, controlling a motor that rotates an auger within the extrusion channel to extrude the composite ink out of the material outlet.

A fiber volume ratio of the milled carbon fibers in the composite ink may be at least 3%. A fiber volume ratio of the milled carbon fibers in the composite ink may be at least 5%. A fiber volume ratio of the milled carbon fibers in the composite ink may be at least 27%. A fiber volume ratio of the milled carbon fibers in the composite ink may be at least 36%. A fiber volume ratio of the milled carbon fibers in the composite ink may be at least 45%.

A strength of the three-dimensional composite structure may be equal to or greater than 400 megapascals. An elastic modulus of the three-dimensional composite structure may be equal to or greater than 53 gigapascals.

In an embodiment, an extrusion system is disclosed that comprises an extruder, wherein the extruder comprises: an extrusion channel configured to hold a composite ink; a material outlet; an actuator configured to extrude the composite ink in the extrusion channel out of the material outlet; and one or more vibration motors configured to vibrate the extrusion channel and the material outlet in one or more axes while the actuator extrudes the composite ink in the extrusion channel out of the material outlet. The material outlet may comprise a nozzle that comprises an opening, through which the composite ink is extruded, that is between 500 microns and 1,000 microns wide. The actuator may comprise a motor connected to an auger within the extrusion channel, wherein the motor rotates the auger in the extrusion channel. The one or more vibration motors may comprise a plurality of vibration motors. The one or more axes may comprise at least six axes. The extruder may further comprise a material inlet port in fluid communication with the extrusion channel, wherein the extrusion system further comprises: a material supply system comprising a material outlet port, a chamber configured to hold the composite ink and in fluid communication with the material outlet port, and an actuator configured to push the composite ink from the chamber out of the material outlet port; and a connector that connects the material outlet port of the material supply system to the material inlet port of the extruder.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates the relationship between fiber volume ratio and strength of short-fiber-reinforced composites produced in previous studies;

FIGS. 2A and 2B illustrate an extrusion system, according to an embodiment;

FIG. 3 illustrates the top and bottom surfaces of two composite samples, printed according to an embodiment;

FIG. 4 demonstrates examples of complex geometries that can be printed according to embodiments;

FIG. 5 illustrates the flexure strength and flexure modulus of composite samples, printed according to embodiments;

FIGS. 6A and 6B represent scanning electron microscope (SEM) images of a composite sample, printed according to an embodiment;

FIG. 7 illustrates the strength of composite samples, printed according to embodiments, as a function of density;

FIGS. 8A and 8B illustrate the elastic modulus and strength of composite samples, printed according to embodiments, as a function of fiber volume ratio;

FIG. 9 illustrates a load transfer and fictitious transformation that are believed to occur in composites that are printed according to embodiments;

FIG. 10 illustrates transversely-printed and longitudinally-printed composite samples, according to an embodiment; and

FIG. 11 illustrates a comparison of the flexure modulus and flexure strength of composite samples, printed in the longitudinal and transverse directions according to embodiments, for different fiber volume ratios.

### DETAILED DESCRIPTION

In an embodiment, systems and methods are disclosed for enhancing the strength of additively manufactured short-fiber-reinforced composites via a fictitious fiber-length transformation. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

An objective of disclosed embodiments is to additively manufacture short-fiber-reinforced thermoset composites with enhanced strength. In an embodiment, the strength limitations of conventional technology are overcome using a vibration-integrated, auger extrusion system. A direct-write additive-manufacturing process may be used to enable the fabrication of short-fiber-reinforced thermoset composites with intricate three-dimensional geometries and unprecedentedly high strength (e.g., 400 MPa or greater), stiffness (e.g., 53 gigapascals (GPa) or greater), and fiber volume ratio (e.g., 46% or greater).

Milled carbon fibers may be used as the reinforcing short fibers. However, other types of short fibers (e.g., Kevlar) may be used in alternative embodiments. Notably, milled carbon fibers were previously considered to be too short to enhance the mechanical strength of composites. However, the inventors have found that, at high fiber volume ratios, an unexpected transformation takes place on the load-transport mechanism within the composites, such that higher levels of strength and stiffness are obtained. This transformation is referred to herein as a “fictitious” transformation, because it causes the short fibers to act as if they are longer. This helps the effective load transfer of tensile loads from the matrix phase to short fibers. The enhanced reinforcement ability of the short fibers, achieved by this transformation, produced an unprecedented level of mechanical performance in the resulting composite. The mechanical properties of the thermoset composites, additively manufactured using the disclosed embodiments, match those of commonly used metals. In addition, these mechanical properties show nearly isotropic behavior. Thus, the disclosed embodiments have immediate application to contexts in which both weight reduction and geometric complexity are desired.

In addition, the disclosed embodiments produce these high-strength composite materials at low cost, enabling the production of these composite materials on a larger scale and for a wider range of applications. The disclosed embodiments can overcome the existing challenges in conventional direct-write additive manufacturing of short-fiber-reinforced thermoset composites, which limit the fiber volume ratio in the resulting composites. Previously, fiber loading over 5% by volume was not possible, since the viscosity of the composite ink increased significantly above this fiber volume ratio, such that extremely high pressures were required to pump these composite inks through sub-millimeter nozzle orifices.

### 1. EXAMPLE EXTRUSION SYSTEM

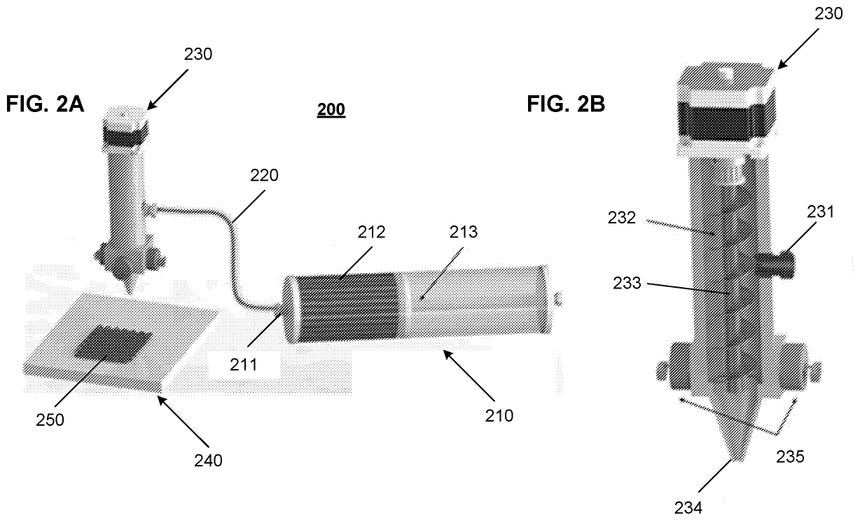

FIGS. 2A and 2B illustrate a direct-write extrusion system 200 for fabricating sintered composite samples, according to an embodiment. Specifically, FIG. 2A illustrates extrusion system 200 for extruding highly viscous composite materials during a printing operation. In the illustrated embodiment, system 200 comprises a material supply system 210, a connector 220, an extruder 230, and a printing platform 240. FIG. 2B is a schematic representation of extruder 230, according to an embodiment. In the illustrated embodiment, extruder 230 comprises a material inlet port 231, an extruder channel 232, an auger 233, a material outlet 234, and one or more vibration motors 235. Extrusion system 200 may be a component of a 3D printing system and may be controlled by one or more processors of the 3D printing system to print a 3D composite structure according to a schematic (e.g., represented by a stereolithography (STL) file).

Material supply system 210 may comprise a material outlet port 211, a chamber 212 (e.g., a barrel with an inner diameter of 50 millimeters), and a piston 213. Chamber 212 is configured to contain highly viscous composite material. Piston 213 may be driven by an actuation system (not shown), such as a stepper motor, to push the composite material out of chamber 212, through material outlet port 211, into connector 220. The actuation system may be driven under the control of one or more processors, for example, of a 3D-printing system.

Connector 220 connects material outlet port 211 of material supply system 210 to material inlet port 231 of extruder 230. Thus, as the composite material is pushed out of chamber 212, the composite material flows through material outlet port 211, through connector 220, and through material inlet port 231 into extruder channel 232 of extruder 230.

In an embodiment, an auger 233 extends through extruder channel 232 of extruder 230. Auger 233 may comprise a helical shaft that is rotated by a motor. The motor may be driven under the control of one or more processors, for example, of a 3D-printing system. As auger 233 rotates, it extrudes the composite material in extruder channel 232 through material outlet 234 (e.g., comprising a nozzle) onto printing platform 240, for example, of a 3D-printing system. One or both of extruder 230 and printing platform 240 may move in one, two, or three dimensions, as the composite material is extruded, such that a three-dimensional composite structure 250 is formed on printing platform 240 from the extruded composite material.

This two-step direct-write extrusion system 200 with displacement control enables highly viscous composite inks, with high short-fiber volume ratios, to be extruded. In addition, extruder 230 may comprise one or more, and preferably a plurality of, vibration motors 235. In an embodiment, extrusion system 200 comprises a plurality of vibration motors 235 (e.g., six) that produce vibration along different axes (e.g., six vibration motors 235 that collectively produce vibration along six axes) or one or more vibration motors 235 that produce vibration along a plurality of axes (e.g., a single vibration motor 235 that produces vibration along six axes). It should be understood that extrusion system 200 may comprise any number of vibration motors 235 that produce vibration along any number of axes. Each vibration motor 235 simultaneously shakes the nozzle of material outlet 234 and the walls of extruder channel 232. This shaking prevents the composite material from adhering to the nozzle and the walls of extrusion system 200 while also preventing fiber agglomeration. Thus, vibration motor(s) 235 may significantly reduce clogging of material outlet 234 and facilitate consistent flow of composite materials with high fiber volume ratios.

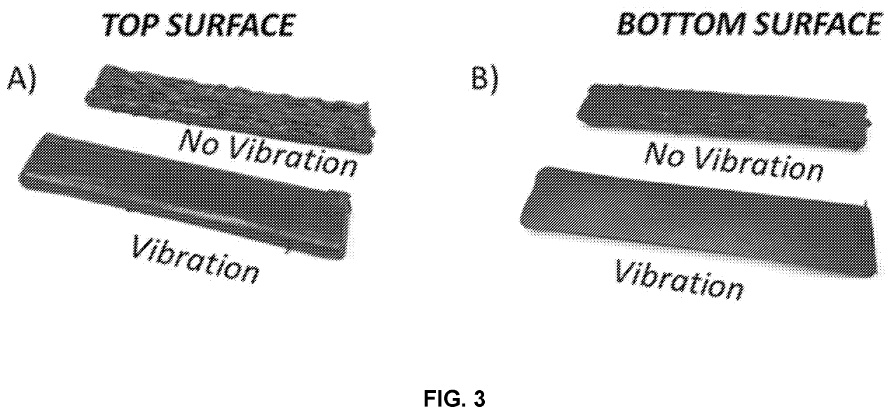

FIG. 3 illustrates the top and bottom surfaces of two test samples that were printed, using composite materials with high fiber volume ratios (i.e., 36% carbon fibers by volume), without and with vibration motors 235. As demonstrated in FIG. 3, both of the surfaces of the test sample that was created without vibration motors 235 are highly irregular, whereas both of the surfaces of the test sample that was created with vibration motors 235 are substantially smooth and uniform. Thus, it is clear that the vibration produced by vibration motor(s) 235 improves the consistency of material flow and the porosity of the printed test samples.

### 2. MILLED CARBON FIBERS

Previous studies on additive manufacturing for short-fiber-reinforced thermosets utilized relatively long fibers with high aspect ratios (i.e., ratio of length to width) in the range of 46 to 234. These selections are consistent with the idea that mechanical loads are more effectively transferred via longer fibers with higher aspect ratios, to thereby achieve higher strengths. However, the use of fibers with high aspect ratios during material extrusion leads to fiber agglomeration, nozzle clogging, and printing defects for composite materials with high fiber volume ratios.

Thus, in an embodiment, milled carbon fibers with low aspect ratios can be used (e.g., added to the composite ink) to reinforce the composite material, in order to facilitate continuous extrusion of composite materials with high fiber volume ratios. The milled carbon fibers that are used may have very low lengths and aspect ratios. For example, the milled carbon fibers may have lengths of approximately 50 μm or less and aspect ratios of approximately 4.5 or less.

### 3. EXAMPLE EMBODIMENT

It should be understood that the use of the displacement-controlled extrusion system 200, with vibration motors 235 to prevent clogging, and the use of milled carbon fibers as the short-fiber reinforcement in the extruded composite material, are two aspects that independently improve the additive manufacturing process for thermoset composites. Thus, these aspects could be used separately from each other in separate embodiments. However, in a preferred embodiment, the disclosed extrusion system 200 and milled carbon fibers are used in combination to maximize the fiber volume ratio in thermoset composites.

### 4. EXPERIMENTAL DATA

### 4.1. Materials and Methods

In an experiment of the disclosed embodiments, composite samples with up to a 46% fiber volume ratio were printed with consistent material flow. The composite ink was prepared by mixing epoxy resin (e.g., EPON™ Resin 826 produced by Hexion Inc. of Columbus, Ohio), curing agent/hardener (e.g., 1-Ethyl-3-methylimidazolium dicyanamide) produced by Sigma-Aldrich of St. Louis, Mo., and Garamite-7305 nanoclay produced by BYK Additives & Instruments of Wesel, Germany. Milled carbon fibers were then added gradually to this mixture in different amounts to observe their effects on mechanical properties and printability. The volume ratios of these chopped fibers to neat epoxy were ranged from 2% up to 46%. The composite inks were subsequently shear mixed using a high shear mixer (e.g., ARE-310 by Thinky U.S.A., Inc. of Laguna Hills, Calif.) for three minutes with a speed of 2,000 revolutions per minute to ensure homogeneity.

The prepared ink was extruded through the nozzle of material outlet 234 attached to a custom delta 3D-printer, comprising extrusion system 200, while the printing speed was maintained at 40 millimeters per second. The material deposition was performed at high geometrical resolution, primarily using a 0.6 millimeter tapered nozzle (e.g., for material outlet 234). In other words, the opening of the nozzle was 600 microns wide. However, for material deposition of composite material with the highest fiber volume ratio (e.g., 46%), a slightly larger 0.84 mm nozzle was used (e.g., for material outlet 234) to provide more continuity in the material flow. In other words, the opening of the nozzle was 840 microns wide. In general, in an embodiment, the opening of material outlet 234 is between 500 and 1,000 microns wide (e.g., in diameter in an embodiment in which the opening is circular). However, it should be understood that the opening of material outlet 234 may have other widths, as appropriate for the application.

During the printing process, printing platform 240 was covered with Teflon tape. This avoided adhesion between composite samples 250 and printing platform 240, and enabled easy removal of the cured samples. All of the fabricated composite samples were printed at room temperature. Curing was carried out in an oven at a temperature of 100° C. for fifteen hours.

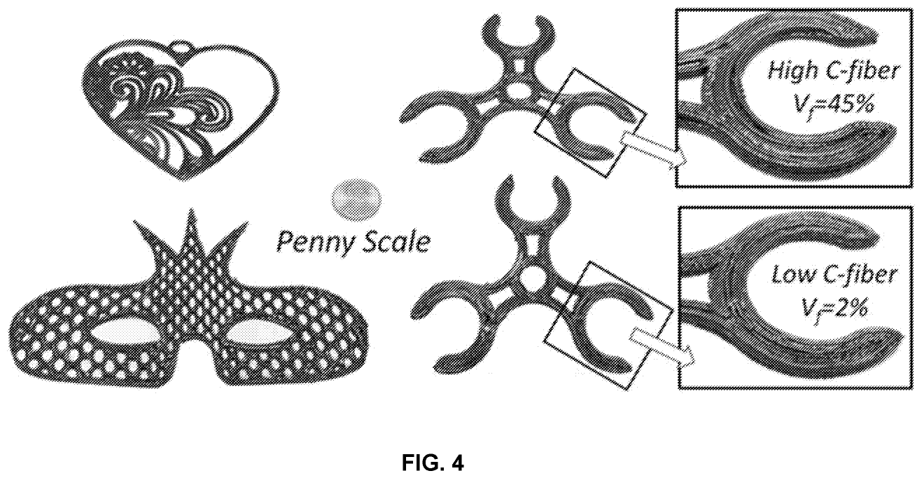

FIG. 4 demonstrates the complex geometries that can be printed using the disclosed embodiments. As illustrated, high dimensional accuracy was achieved with short-fiber-reinforced thermoset composites. The disclosed embodiments were able to fabricate intricate geometries, even with composite materials having very high fiber volume ratios (e.g., 45%), as evidenced in FIG. 4 by the similarity between composite samples printed with low fiber volume ratios (i.e., 2%) and composite samples printed with high fiber volume ratios (i.e., 45%).

In order to assess the mechanical properties of the 3D-printed composite samples, three-point bending tests were performed using a Universal Testing System produced by Instron of Norwood, Mass. The tests were performed in accordance with the American Society for Testing and Materials (ASTM) D7264/D7264M-07 standard (i.e., Standard Test Method for Flexural Properties of Polymer Matrix Composite Materials). At least four tests were performed for each set to provide repeatability and quantify experimental variability. A 16:1 span-to-thickness ratio was utilized, with the span length adjusted for each composite sample to maintain this ratio. In addition to printing in the longitudinal direction (i.e., print lines parallel to the bending loads), composite samples were also printed in the transverse direction (i.e., print lines perpendicular to the bending loads), in order to quantify the level of anisotropy in the additively manufactured composite samples. Three different fiber volume ratios were selected for the transverse printing: low (5%); medium (20.2%); and high (36.1%).

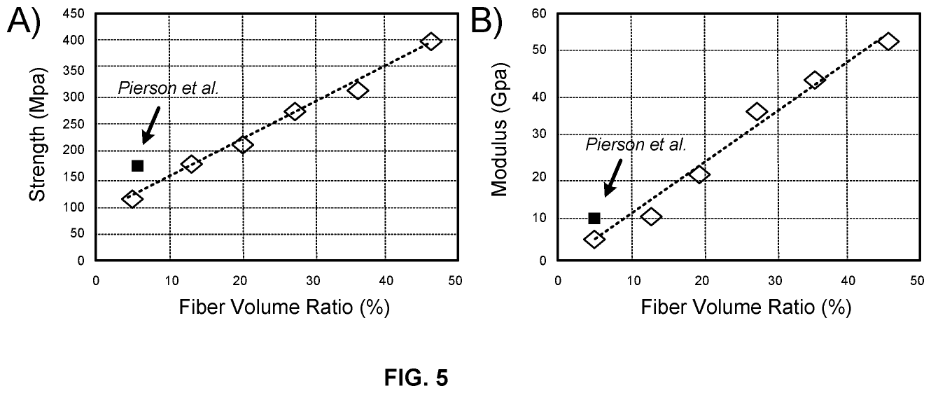

FIG. 5 illustrates the flexure strength (graph A) and flexure modulus (graph B) of the composite samples, printed according to the disclosed embodiments, as a function of fiber volume ratio. As illustrated, the flexure strength and modulus increase substantially linearly as the carbon fiber amount is increased. For comparison of the mechanical performance of the fabricated composite samples to the state of the art, the flexure strength and modulus properties of the 3D-printed samples reported by Pierson et al. are marked in FIG. 5. As indicated, the short-fiber-reinforced composite samples, produced by the disclosed embodiments, exhibited a nearly three-fold increase in strength and a nearly five-fold increase in modulus compared to the state of the art. It is believed that this dramatic increase in strength and modulus is mainly due to the increased fiber volume ratio from 5% to 46% using extrusion system 200. The results also show that, for the same fiber volume ratio (e.g., approximately 5%), similar mechanical performance was achieved using milled carbon fibers (e.g., with an aspect ratio of approximately 4.5), compared to the composites with higher aspect ratios (i.e., an aspect ratio of 63) reported by Pierson et al. This demonstrates the potential of milled carbon fibers for the fabrication of high-strength composite materials.

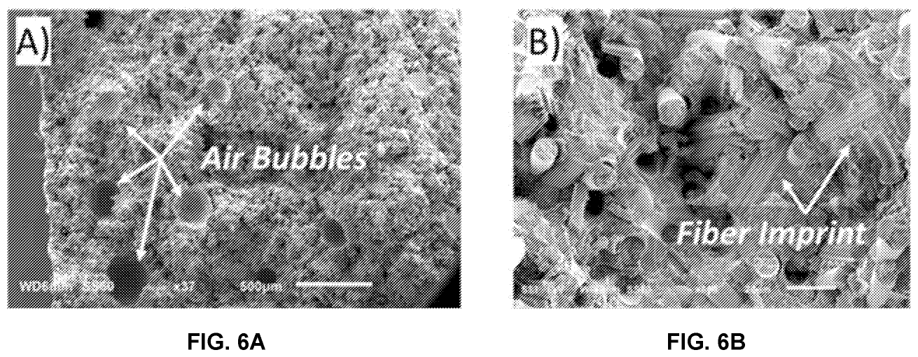

Fracture surfaces of the composite samples were imaged using a scanning electron microscope (e.g., JOEL JSM-6010 PLUS/LA Analytical Scanning Electron Microscope) following the mechanical testing described above. The composite samples were initially sputter-coated with a thin (e.g., 1-2 nanometers) layer of gold under fifty torr for thirty seconds. FIGS. 6A and 6B represent SEM images of a composite sample that was reinforced with 46% milled carbon fibers by volume. Specifically, FIG. 6A is a low-magnification image that shows porosity, and FIG. 6B is a high-magnification image that shows fiber orientation. These fractographs demonstrate that the fibers are densely packed at high fiber volume ratios.

As illustrated in FIG. 6A, large porosities (e.g., air bubbles) exist within the composite sample, despite the composite sample's unprecedentedly high mechanical strength and modulus. If these porosities are eliminated prior to the extrusion of the composite material, the mechanical properties of the composite sample can be further enhanced. Thus, the disclosed embodiments may be combined with techniques to reduce porosities in order to achieve even more enhanced strength.

As illustrated in FIG. 6B, the fibers show some alignment in the printing direction (i.e., perpendicular to the fracture plane). This alignment is significantly lower than those reported in previous studies on 3D-printed carbon fiber polymer composites in which fibers with higher aspect ratios were utilized. Thus, the disclosed embodiments may be combined with techniques to increase fiber alignment in order to achieve even more enhanced strength.

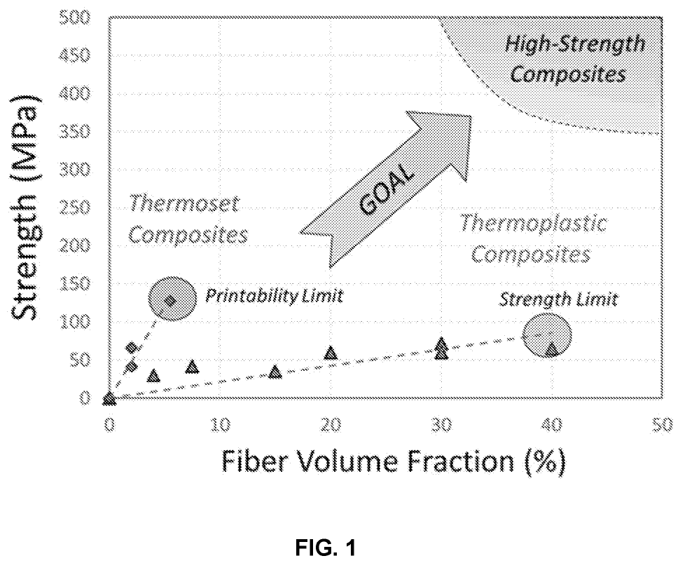

The experiments demonstrated that the disclosed embodiments achieved additive manufacturing of short-fiber-reinforced composites with high fiber volume ratios and high strength, contrary to the limitations of the previous studies illustrated in FIG. 1. The manufacture of composite structures, having high strength and stiffness (or modulus) and complex geometries, may have a tremendous impact in various applications, including in the aerospace, defense, and marine industries. For a given strength requirement, such composite structures offer lower material costs, easier processing, higher chemical resistance, and reduced weights compared to the state of the art.

### 4.2. Unexpected Results

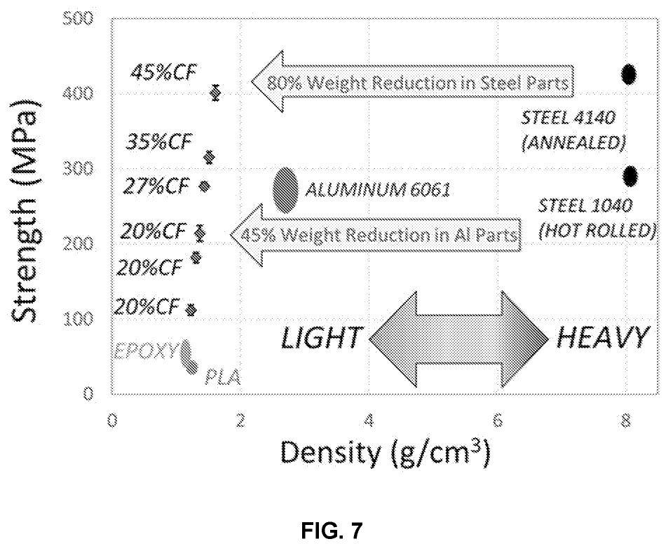

FIG. 7 illustrates the strength of composite samples fabricated, via direct-write additive manufacturing, as a function of their densities, according to an embodiment. For comparison, the properties of commonly used polymer materials (i.e., PLA, epoxy) and metals (i.e., aluminum and steel) are also marked in FIG. 7. As the carbon fiber (CF) content is increased in the fabricated thermoset composites, the composite density showed a linearly increasing trend. Composites that were reinforced with 27% short carbon fibers by volume had equal strength to that of aluminum 6061 alloy, which is commonly used for aerospace, automotive, and marine applications. However, the density of this composite was 45% lower than the density of aluminum 6061 alloy. Therefore, additively manufactured thermoset composites can replace 6061 aluminum alloy components, while reducing the weights of such components by nearly half. More significant weight reductions can be achieved with higher fiber volume ratios. For example, composites that were reinforced with 46% short carbon fibers by volume exceeded the yield strength of hot rolled steel and matched the strength of annealed 4140 steel. Considering the densities of steel (8.9 g/cm³) and the additively manufactured composite sample of this experiment (1.6 g/cm³), an 80% reduction in weight can be achieved by replacing steel parts with composites manufactured according to the disclosed embodiments.

The elastic modulus of short-fiber-reinforced composites can be predicted by the well-known Halphin-Tsai analytical model described in “Advances in Applied Mechanics,” by Budarapu et al., vol. 52, pp. 1-103 (2019), which is hereby incorporated herein by reference as if set forth in full. Assuming that all fibers are aligned perfectly in the printing direction, the Halphin-Tsai model predicts the elastic modulus of the composite E_{C} as follows:

$${E}_{C} = \frac{( 1 + 2 s {η}_{L} f )}{1 - {η}_{L} f} {E}_{m} where {η}_{L} = \frac{( {E}_{r} / {E}_{m} - 1 )}{{E}_{r} / {E}_{m} + 2 s}$$

wherein s is the aspect ratio of the fibers, f is the fiber volume ratio, Eᵣ is the elastic modulus of the fiber reinforcement, and Eₘ is the elastic modulus of the fiber matrix.

The strength σ_{C} of the short-fiber-reinforced composites can also be predicted using models described in “A model to predict the strength of short fiber composites,” by Hattum et al., J. Polymer Composites 20, 524-33 (1999), and “Materials Selection in Mechanical Design,” by Ashby, 4th ed. (Elsevier, 2011), which are both hereby incorporated herein by reference as if set forth in full. Unlike the elastic modulus, the critical aspect ratio s_{c} plays an important role in estimating the composite strength. The ultimate strength of a material with perfectly aligned fibers can be calculated as:

$${σ}_{C} = \{ \begin{matrix}fs \frac{{σ}_{m}}{\sqrt{3}} + ( 1 - f ) {σ}_{m} , & s < {s}_{c} \\ f {σ}_{r} ( 1 - \frac{{σ}_{r} \sqrt{3} )}{4 s {σ}_{m}} ) + ( 1 - f ) {σ}_{m} , & s \geq {s}_{c}\end{matrix} where {s}_{c} = \frac{{σ}_{r} \sqrt{3}}{2 {σ}_{m}}$$

wherein σᵣ is the strength of the fiber reinforcement, and σₘ is the strength of the fiber matrix.

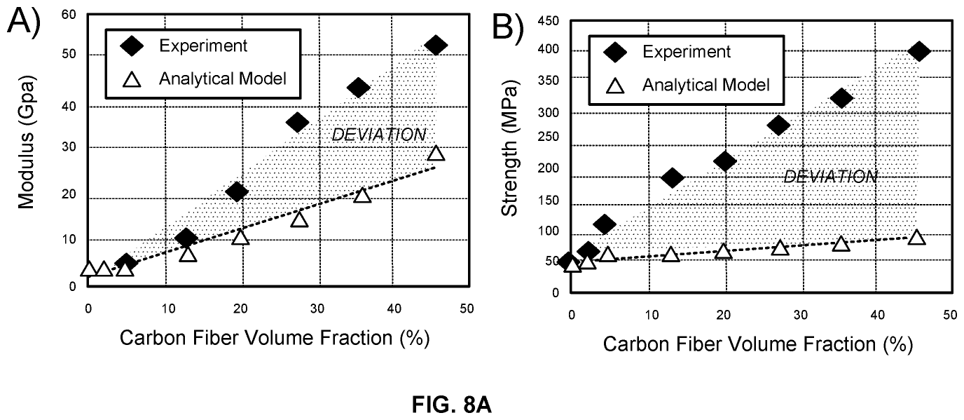

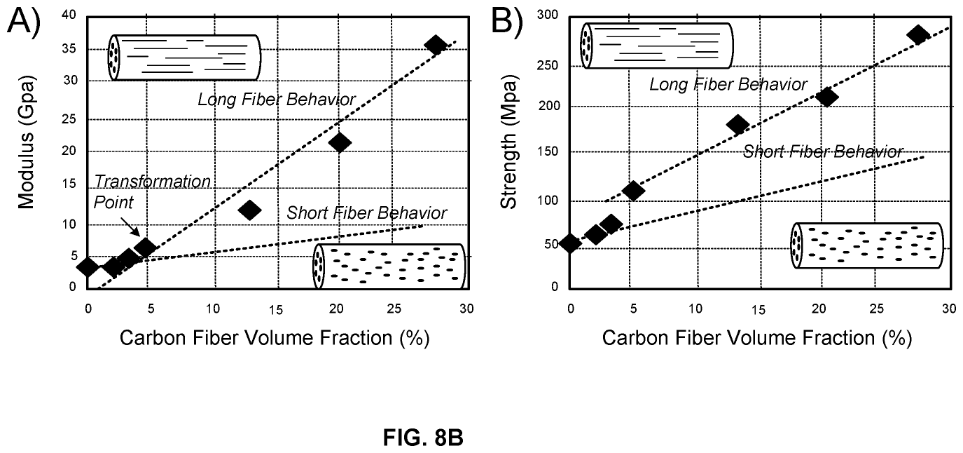

FIG. 8A illustrates the predicted and actual elastic modulus and ultimate strength, respectively, of the composite samples in the experiment, as a function of fiber volume ratio. As demonstrated in FIG. 8A, the analytical model significantly underpredicted the strength and modulus of the fabricated composite samples. In other words, composites, fabricated according to disclosed embodiments, were significantly stronger (e.g., approximately 4 times stronger) and stiffer (e.g., approximately 2 times stiffer) than the expected mechanical properties. In fact, the deviation between the predicted data and the experimental data is larger in reality, since the analytical model assumes perfectly aligned fibers and the fibers in the composite samples were not well aligned in the printing direction, as demonstrated by FIG. 6B. Thus, if the analytical model were to compensate for the fiber misalignment, the predicted strength and modulus values would decrease, thereby increasing the deviation between the predicted values and the actual values in the experimental data.

Notably, the deviation between the predicted values and actual experimental values is larger in the case of strength. This is because the predicted strength values are computed based upon the critical aspect ratio for the fiber-reinforced composites. As the equation for σ_{C} indicates, if the fiber aspect ratio is below the critical value s_{c}, fiber tensile strength does not contribute to the strength of the composite. The critical aspect ratio s_{c} depends on the fiber and matrix strengths, and was calculated to be 80, which was significantly larger than the aspect ratio (s=4.5) for the milled fibers used in the experiment. Previous studies claimed that, if the fiber aspect ratio was significantly less than the critical value s_{c}, the matrix would deform around the fibers, such that there is virtually no stress transference and little reinforcement by the fibers. See “Material Science and Engineering: an Introduction,” by Calliser et al. (2014), which is hereby incorporated herein by reference as if set forth in full. Thus, the strength of the composite samples produced by the disclosed embodiments was unexpected.

It is not entirely understood why the additively manufactured composites of the disclosed embodiments are much stronger than predicted, or how these very short fibers, which are nearly twenty times smaller than the critical aspect ratio s_{c}, reinforce the additively manufactured composites so effectively. However, FIGS. 8A and 8B provide some clues about this peculiar behavior.

FIG. 8B is a close-up view of the lower fiber volume ratios in FIG. 8A. As shown, the analytical model predictions and the experimental data compare well at low fiber volume ratios. At these low fiber volume ratios, the fibers minimally reinforce the composite, as expected from the milled, short fibers. However, above the 3% fiber volume ratio, the strength and stiffness deviations increase dramatically as a function of fiber volume ratio. In fact, after this critical fiber loading (e.g., approximately 3%), which is marked as the transformation point in FIG. 8B, the fibers behave like long fiber reinforcements with high aspect ratios, to reinforce the composite more effectively.

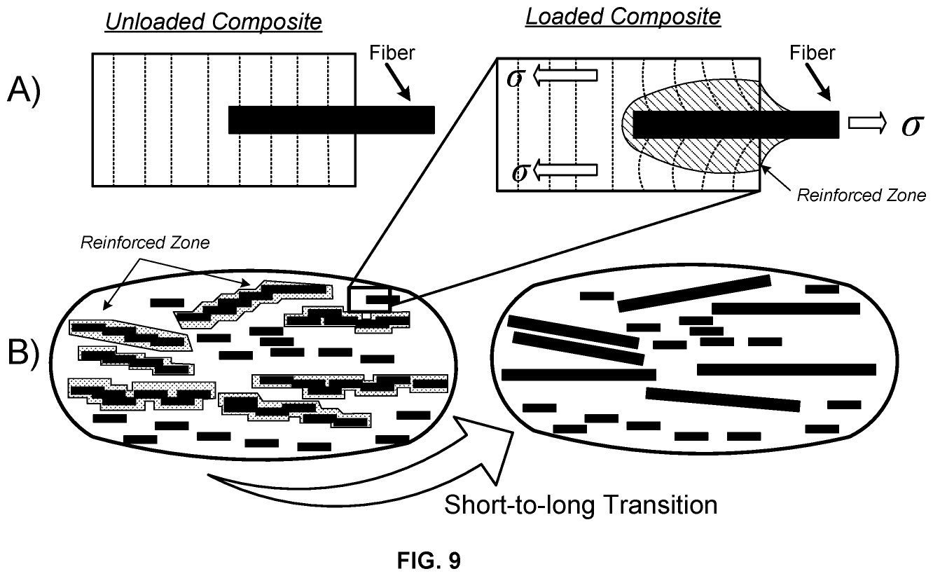

As illustrated in FIG. 8B, the shift from short fiber behavior to longer fiber behavior, in terms of both modulus and strength, is observed at a saturation level (i.e., fiber volume ratio) of 3%. This may be explained by the enhancement of the load transmittal zone, or reinforcement zone, as shown in FIG. 9. Specifically, illustration A in FIG. 9 is a schematic of load transfer between a short fiber and the polymer matrix under tensile loading, with dashed lines showing the change of displacements due to shear force between the matrix and the fiber. Illustration B in FIG. 9 depicts the proposed mechanism for the short-to-long fiber transformation at high fiber volume ratios, with highlighted regions shown for fibers with overlapped reinforcement. The mechanical properties of fiber-reinforced composites depend not only on the properties of the fiber and matrix, but also on the degree of load transmission from the matrix phase to the fibers. Interfacial adhesion between the fiber and the matrix phases and the length (or aspect ratio) of the fibers determine the level of load transmittance. As shown in FIG. 9, under an applied load, the load transmittance from the matrix to the fiber is carried out mainly by the lateral surfaces. Therefore, if the fiber matrix interface is weak, such as in thermoplastic composites, or if the lateral fiber surface is small (e.g., short fibers with low aspect ratios), load transmittance cannot be performed effectively. However, if the matrix is loaded with fibers above the saturation/transformation concentration of 3% (e.g., as shown in FIG. 8B), reinforcement zones, shown in FIG. 9, might become overlapping. Therefore, the force is distributed collaboratively by sets of fibers acting collectively to behave like a single longer fiber. The strong cohesion of fibers in these reinforced zones provide high reinforcement ability. Below the saturation concentration of 3%, the matrix may deform around the fibers, causing a comparative reduction in strength and stiffness.

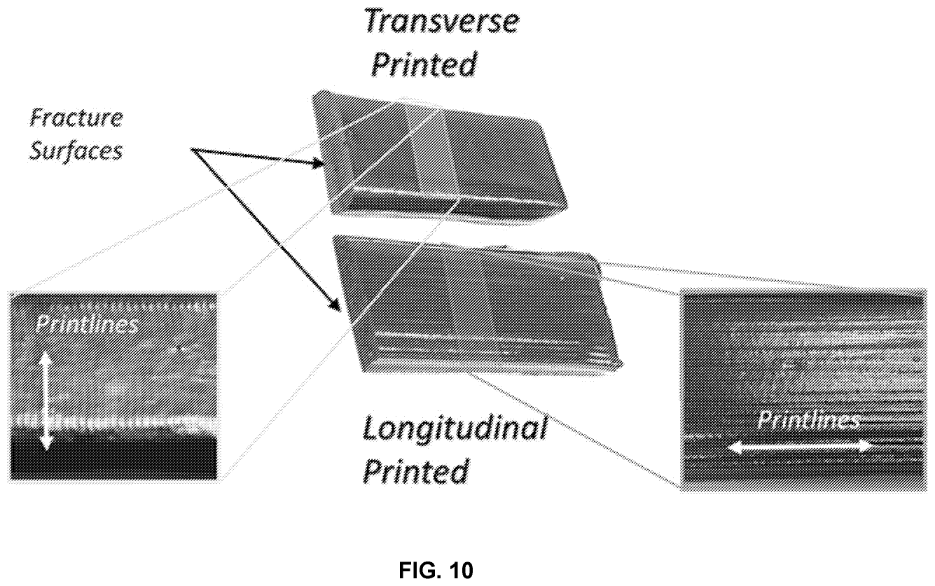

One of the key characteristics of additively manufactured fiber-reinforced composites is that they are highly anisotropic. In other words, the strength and stiffness of these materials are significantly higher in the longitudinal direction than in any other direction. This anisotropy greatly benefits the strength-to-weight ratio of fiber-reinforced composites in the longitudinal direction in which fibers show maximum alignment. However, this anisotropy also limits these composites' utility in applications in which the material must have strength in multiple loading directions. In order to assess the anisotropy of the short-fiber-reinforced composite samples, mechanical tests were performed on composite samples printed in the transverse direction. The weakest mechanical properties are generally expected in the transverse direction. In transversely printed composite samples, the print lines extend perpendicular to the loading direction as shown in FIG. 10.

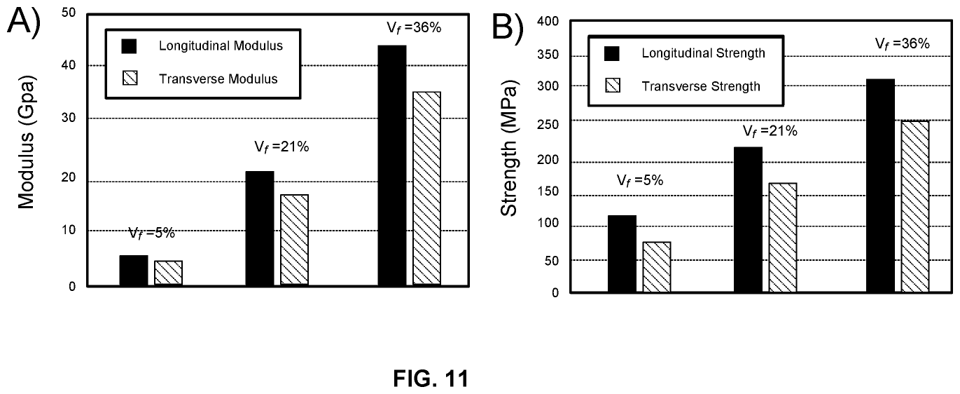

FIG. 11 illustrates a comparison of the flexure modulus (graph A) and flexure strength (graph B) of the composite samples printed in the longitudinal direction (i.e., parallel to the loading) and transverse direction (i.e., perpendicular to the loading) for three different fiber volume ratios. As indicated, the transverse properties were slightly lower than the longitudinal properties. However, the mechanical properties measured in the longitudinal and transverse directions differed by less than 20% for the highest fiber volume ratio (i.e., 36%). This anisotropy was far less than anisotropy levels reported in previous studies. In those previous studies, the transverse properties were significantly (e.g., approximately 70%) lower than the longitudinal properties. The near-isotropic properties of the composites, additively manufactured according to the disclosed embodiments, were also evidenced by SEM imaging as shown in FIG. 6B, which demonstrates low alignment of fibers in the longitudinal direction. Compared to the longer fibers preferred in the previous studies, milled carbon fibers with low aspect ratios showed less alignment under shear stress during the extrusion process and caused higher isotropy during the extrusion process.

### 4.3. Conclusions

According to disclosed embodiments, high-strength short-fiber-reinforced composites were created by direct-write additive manufacturing. The strength (e.g., greater than 400 MPa) and the modulus of (e.g., greater than 53 GPa) of the fabricated composites far exceeded those achieved by previous studies. This unprecedented and unexpected mechanical performance was achieved by a custom direct-write extrusion system 200 that enabled an increase in the fiber volume ratio from 5% to 46%. Extrusion system 200 enabled printing with highly viscous composite inks without the flow inconsistences and nozzle clogging issues of conventional systems.

Even at high fiber volume ratios, the results were unexpectedly high in comparison to the established analytical mechanical models. This may be due to the fact that the fibers used in the experiments were milled fibers with low aspect ratios that were much less than the calculated critical aspect ratio. The analytical mechanical models predicted that effective strength enhancement cannot be achieved using fibers with aspect ratios less than the critical level. Experiments with the disclosed embodiments demonstrated that these analytical mechanical models can successfully predict the experimental results at low fiber volume fractions. However, after a critical level (e.g., approximately 3%), fibers can strengthen the composites much more effectively. This may be explained by the overlapping reinforcement zones formed by groups of multiple fibers within vicinities of each other. Due to the strong cohesion within these overlapping reinforcement zones, the load may be transferred collaboratively by the groups of multiple fibers. Therefore, a fictitious transformation may occur that, in terms of mechanical properties, transforms each group of multiple short fibers into a long fiber in terms of behavior. This could explain the enhanced strength of the composite samples at high fiber volume ratios.

In addition to the improved mechanical performance of additively manufactured composites in the longitudinal direction, mechanical properties were nearly as good in the weakest, transverse direction. Considering the high strength and stiffness, material isotropy, low cost, and flexibility of fabrication, additively manufactured short-carbon-fiber-reinforced composite may benefit a wide range of applications. These composites have the potential to replace commonly used structural metals, such as aluminum and low-strength steels, with significant weight reduction. The mechanical properties of these materials can be further enhanced by optimizing the additive manufacturing parameters and reducing defects to reduce porosity in the composite. In addition, if the alignment of short fibers can be improved by optimizing the printing process parameters, the improved fiber alignment will further enhance the strength and modulus of the composite materials along the longitudinal direction and maximize anisotropy.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method of manufacturing a fiber-reinforced composite, the method comprising:
supplying an extrusion channel with a composite ink comprising short fibers having an average length of 50 μm or less and an average aspect ratio of 4.5 or less; and
extruding the composite ink out of a material outlet of the extrusion channel, while vibrating the extrusion channel and the material outlet by one or more vibration motors along one or more vibration axes, to fabricate a three-dimensional composite structure.

2. The method of claim 1, wherein the short fibers comprise milled carbon fibers.

3. The method of claim 1, wherein the one or more vibration motors are a plurality of vibration motors.

4. The method of claim 1, wherein the one or more vibration axes are at least six vibration axes.

5. The method of claim 1, wherein supplying the extrusion channel with the composite ink comprises, by at least one processor, controlling an actuator to feed the composite ink into the extrusion channel.

6. The method of claim 5, wherein the actuator comprises a motor that drives a piston, and wherein feeding the composite ink into the extrusion channel comprises controlling the motor to drive the piston to push the composite ink from a supply chamber into the extrusion channel.

7. The method of claim 1, wherein extruding the composite ink out of the material outlet of the extrusion channel comprises, by at least one processor, controlling a motor that rotates an auger within the extrusion channel to extrude the composite ink out of the material outlet.

8. The method of claim 1, wherein a fiber volume ratio of the milled carbon fibers in the composite ink is at least 3%.

9. The method of claim 1, wherein a fiber volume ratio of the milled carbon fibers in the composite ink is at least 5%.

10. The method of claim 1, wherein a fiber volume ratio of the milled carbon fibers in the composite ink is at least 27%.

11. The method of claim 1, wherein a fiber volume ratio of the milled carbon fibers in the composite ink is at least 36%.

12. The method of claim 1, wherein a fiber volume ratio of the milled carbon fibers in the composite ink is at least 45%.

13. The method of claim 1, wherein a strength of the three-dimensional composite structure is equal to or greater than 400 megapascals.

14. The method of claim 13, wherein an elastic modulus of the three-dimensional composite structure is equal to or greater than 53 gigapascals.

15. An extrusion system comprising an extruder, wherein the extruder comprises:
an extrusion channel configured to hold a composite ink;
a material outlet;
an actuator configured to extrude the composite ink in the extrusion channel out of the material outlet; and
one or more vibration motors configured to vibrate the extrusion channel and the material outlet in one or more axes while the actuator extrudes the composite ink in the extrusion channel out of the material outlet.

16. The extrusion system of claim 15, wherein the material outlet comprises a nozzle that comprises an opening, through which the composite ink is extruded, that is between 500 microns and 1,000 microns wide.

17. The extrusion system of claim 15, wherein the actuator comprises a motor connected to an auger within the extrusion channel, wherein the motor rotates the auger in the extrusion channel.

18. The extrusion system of claim 15, wherein the one or more vibration motors comprise a plurality of vibration motors.

19. The extrusion system of claim 15, wherein the one or more axes comprise at least six axes.

20. The extrusion system of claim 15, wherein the extruder further comprises a material inlet port in fluid communication with the extrusion channel, and wherein the extrusion system further comprises:
a material supply system comprising a material outlet port, a chamber configured to hold the composite ink and in fluid communication with the material outlet port, and an actuator configured to push the composite ink from the chamber out of the material outlet port; and
a connector that connects the material outlet port of the material supply system to the material inlet port of the extruder.
